(19) United States
(12) Patent Application Publication
(10) Pub. No.: US 2007/0022203 A1
(43) Pub. Date: Jan. 25, 2007

(54) Method and apparatus for providing proxied JMX interfaces to highly available J2EE components

(75) Inventors: Marc Edward Haberkorn, Raleigh, NC (US); Brian Keith Martin, Cary, NC (US); William Thomas Newport, Rochester, MN (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/184,500

(22) Filed: Jul. 19, 2005

(51) Int. Cl. G06F 15/16

(52) U.S. Cl. 709/230

(57) ABSTRACT

Method and apparatus, in a data processing system that uses JMX as a mechanism for managing internal components, for processing JMX requests to a managed group that includes a plurality of group members. When a JMX request is transmitted to a first member of a group comprising a plurality of group members, a determination is made if the first member is in an active state capable of processing the request. If the first member is not in an active state, the JMX request is forwarded to a currently active member of the plurality of members for processing the request. The invention thus permits users to communicate with the group via JMX without knowing which member of the group is active at any particular time.

### BACKGROUND OF THE INVENTION

1. Field of the Invention

The present invention relates generally to the data processing field, and more particularly, to a method and apparatus for facilitating communication with a data processing system that uses JMX as a mechanism for managing internal components.

2. Description of the Related Art

WebSphere® software provides high-volume transaction processing for on demand business applications (WebSphere® is a registered trademark of IBM Corporation of Armonk, N.Y., in the United States, other countries, or both). WebSphere® software has been designed with an important priority being the elimination of single points of failure. A prominent feature included in the WebSphere® system in this regard is a High-Availability Manager (referred to as “HAManager”).

The WebSphere system utilizes JMX (Java Management Extensions) as a mechanism for managing internal components, i.e., J2EE (Java 2 Enterprise Edition) components. In order to make use of JMX, a client user must specify a distinct endpoint (host, port) to which to connect. When a singleton service is elected by HAManager from a pool of instances across several processes, however, the selection of the endpoint for connection becomes non-trivial (assuming the client user is outside of the HAManaged group and is not privy to election decisions).

It would, accordingly, be desirable to provide a mechanism that enables client users of a data processing system that uses JMX as a mechanism for managing internal components to access a managed group of components without knowing which member of the group is active at any particular point in time.

### BRIEF SUMMARY OF THE INVENTION

The present invention provides a method and apparatus, in a data processing system that uses JMX as a mechanism for managing internal components, for processing JMX requests to a managed group that includes a plurality of group members. When a JMX request is transmitted to a first member of a group comprising a plurality of group members, a determination is made if the first member is in an active state capable of processing the request. If the first member is not in an active state, the JMX request is forwarded to a currently active member of the plurality of members for processing the request. The invention thus permits users to communicate with the group via JMX without knowing which member of the group is active at any particular time.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 shows a block diagram of a data processing system in which aspects of the present invention may be implemented;

FIG. 3A is a diagram that schematically illustrates two groups of instances that are capable of receiving JMX requests to assist in explaining the present invention;

FIG. 3B is a diagram that schematically illustrates a mechanism for processing JMX requests to the groups illustrated in FIG. 3A according to an exemplary embodiment of the present invention;

FIG. 4A is a diagram that schematically illustrates two groups of instances corresponding to the two groups of instances illustrated in FIG. 3A with a member of each group having gone down to assist in explaining a further aspect of the present invention;

FIG. 4B is a diagram that schematically illustrates a mechanism for processing JMX requests to the groups illustrated in FIG. 4A according to an exemplary embodiment of the present invention; and

FIG. 5 is a flowchart that illustrates a method for processing a JMX request according to an exemplary embodiment of the present invention.

### DETAILED DESCRIPTION OF THE INVENTION

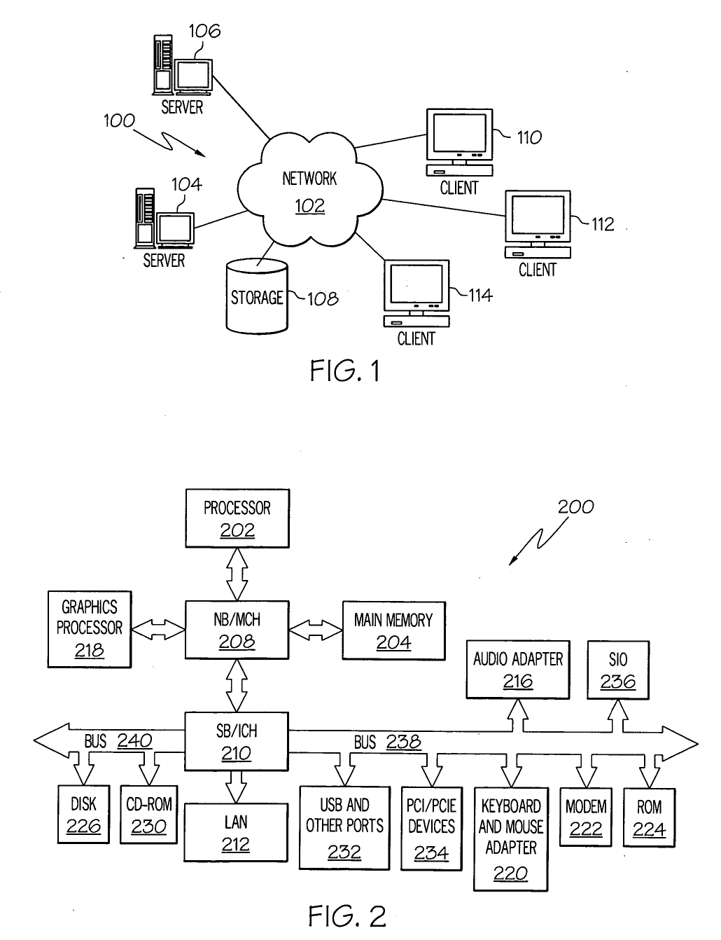

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to. server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server-104 or client 110 in FIG. 1, in which computer usable code or instructions implementing the processes for embodiments of the present invention may be located.

In the depicted example, data processing system 200 employs a hub architecture including north bridge and memory controller hub (MCH) 208 and south bridge and input/output (I/O) controller hub (ICH) 210. Processing unit 202, main memory 204, and graphics processor 218 are connected to north bridge and memory controller hub 208.. Graphics processor 218 may be connected to north bridge and memory controller hub 208 through an accelerated graphics port (AGP).

In the depicted example, local area network (LAN) adapter 212, audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 210 through bus 238. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 210 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 210.

An operating system runs on processing unit 202 and coordinates and provides control of various components within data processing system 200 in FIG. 2. As a client, the operating system may be a commercially available operating system such as Microsoft Windows XP (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 202. Alternatively, a single processor system may be employed.

Instructions for the operating system, the object-oriented programming system, and applications or programs are located on storage devices, such as hard disk drive 226, and may be loaded into main memory 204 for execution by processing unit 202. The processes for embodiments of the present invention are performed by processing unit 202 using computer usable program code, which may be located in a memory such as, for example, main memory 204, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 204, read only memory 224, or a cache such as found in north bridge and memory controller hub 208 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The present invention is directed to a method and apparatus for facilitating communication with a data processing system that uses JMX as a mechanism for managing internal components by enabling client users of the data processing system to access a managed group of components without knowing which member of the group is active at any particular point in time. An example of a data processing system that uses JMX as a mechanism for managing internal components is a data processing system that incorporates WebSphere® software although it should be understood that the invention is not limited to any particular data processing system.

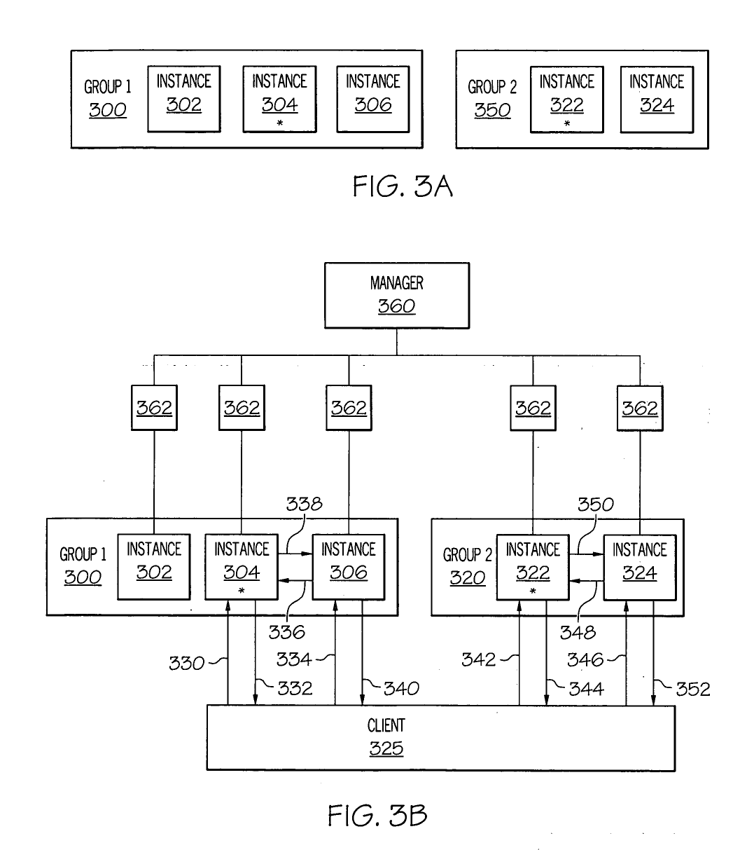

FIG. 3A is a diagram that schematically illustrates two groups of instances that are capable of receiving JMX requests to assist in explaining the present invention. Group 300 includes three components, instances 302, 304 and 306; and group 320 includes two components, instances 322 and 324. As indicated by the * symbol in FIG. 3A, instance 304 in group 300 and instance 322 in group 320 have been elected to be in an active state.

FIG. 3B is a diagram that schematically illustrates a mechanism for processing JMX requests made to the groups illustrated in FIG. 3A according to an exemplary embodiment of the present invention. As shown in FIG. 3B, if a request 330 is made to active instance 304 by client user 325, active instance 304 will process the request locally and return result 332 to client user 325. If a request 334 is made to inactive member 306, on the other hand, the request will be proxied (transferred) to active member 304 for processing as indicated by arrow 336. The request is processed by active instance 304, and returned to inactive instance 306, as indicated by arrow 338 for forwarding to the client user as illustrated by arrow 340.

A request to group 320 will be processed in a similar manner. In particular, as shown in FIG. 3B, with instance 322 in an active state, a JMX request 342 from client user 325 to instance 322 will be processed by instance 322 and result 344 returned to client user 325. A request from client user 325 to inactive instance 324, on the other hand, is proxied to active instance 322 as indicated by arrow 348, is processed locally by active instance 322, and is returned to the client user through instance 324 as indicated by arrows 350 and 352.

Thus, according to the present invention, client user 325 is able to communicate with groups 300 and 320 via JMX without having to know which instance of the groups is active at any particular time. Instead, with the present invention, a request to a currently active instance of a group is processed by that instance, while a request to a currently inactive instance of a group is proxied to the currently active instance of the group for processing. Accordingly, it is only necessary that the user to be able to identify one endpoint (instance) to which to connect to a group in order to have a request to the group processed.

According to an exemplary embodiment of the invention, a client user is enabled to communicate with groups 300 or 320 via JMX without knowing which instance of the groups is active at any particular time by utilizing manager 360 to manage groups 300 and 320. More particularly, a layer is introduced on top of the manager framework which creates an MBean for each instance of managed groups 300 and 320. The MBeans for each instance are schematically illustrated by blocks 362 in FIG. 3B. In a data processing system incorporating WebSphere® software, for example, a layer is provided on top of the HAManager framework which creates an MBean for each member of each managed group. The request handler for an MBean associated with a particular instance is then changed as elections are made in a particular group. Thus, client user 325 is required to know only one of the endpoints in a group in order to effectively communicate with the singleton service represented by that group via JMX.

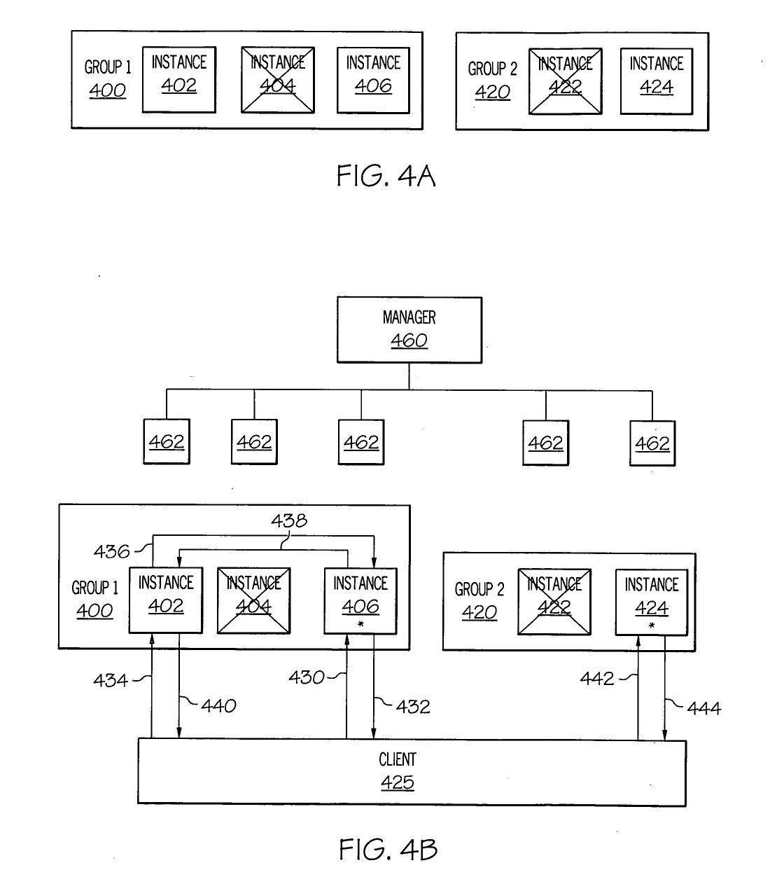

Consider next a situation in which an elected instance of a group goes down for one reason or another. FIG. 4A is a diagram that schematically illustrates two groups of instances 400 and 402 corresponding to groups of instances 300 and 302 illustrated in FIG. 3A with a member of each group having gone down to assist in explaining a further aspect of the present invention. In particular, as shown in FIG. 4A, instance 404 in Group 400 and instance 422 in group 420, both of which were in an active state as described with reference to FIGS. 3A and 3B, have gone down. When this occurs, manager 460 will elect an inactive member of each group to be in an active state.

In particular, FIG. 4B is a diagram that schematically illustrates a mechanism for processing JMX requests to the groups illustrated in FIG. 4A according to an exemplary embodiment of the present invention; As indicated by the * symbol in FIG. 4B, manager 460 has now elected instances 406 and 424 to be in an active state. At the same time, manager 460 changes the request handlers for the appropriate MBeans 462 to reflect the new elections. Therefore, as shown in FIG. 4B, when a request 430 is made to now active instance 406 by client user 425, active instance 406 will process the request locally and return result 432 to user client 425. If a request 434 is made to inactive instance 402, on the other hand, the request will be proxied (transferred) to currently active member 406 for processing as indicated by arrow 436. The request is processed by active instance 406, and returned to inactive instance 402, as indicated by arrow 438 for forwarding to the client user as indicated by arrow 440.

A request to group 420 will be processed in a similar manner. In particular, as shown in FIG. 4B, with instance 424 now in an active state, a JMX request 442 from client user 425 to instance 424 will be processed by instance 424 and result.444 returned to client user 425.

Thus, according to the present invention, should an instance suddenly go down, a currently inactive instance is elected to be active, and the manager changes the request handlers for the appropriate MBeans to reflect the new elections so that client users are still able to communicate with the group without knowing the particular instance that has been made active by the manager. Thus, even though a client may only know one of the endpoints in the group, the client is still able to communicate with the singleton service represented by that group via JMX.

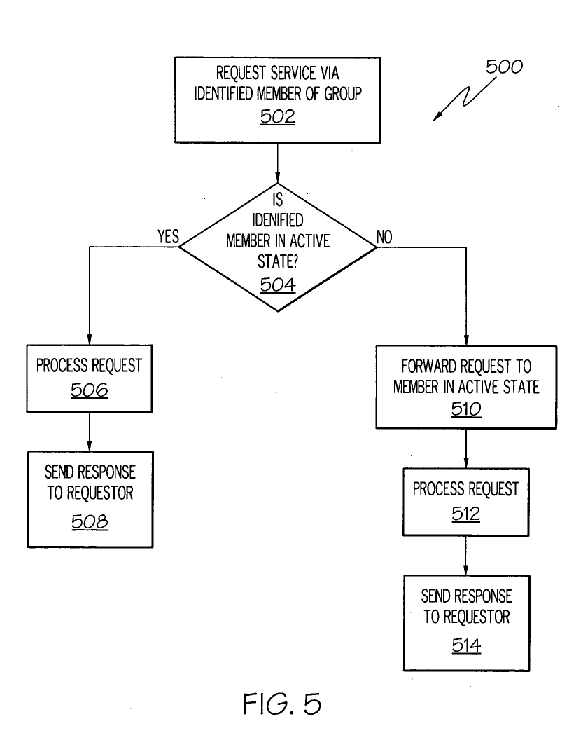

FIG. 5 is a flowchart that illustrates a method for processing a JMX request according to an exemplary embodiment of the present invention. The method is generally designated by reference number 500 and begins with a client requesting a service from a group comprising a plurality of members via connection to an identified member of the group (Step 502). A determination is then made if the identified member is in an active state (Step 504). If the identified member is in an active state (Yes output of Step 504), the request is processed by the identified member (Step 506), and a response to the request is sent to the client (Step 508). If the identified member is in an inactive state (No output of Step 504), the request is sent to a member of the group that is in an active state (Step 510). The further member then processes the request (Step 512) and sends a response to the client via the member that is in an inactive state (Step 514).

The present invention thus provides a method and apparatus, in a data processing system that uses JMX as a mechanism for managing internal components, for processing JMX requests to a managed group that includes a plurality of group members. When a JMX request is transmitted to a first member of a group comprising a plurality of group members, a determination is made if the first member is in an active state capable of processing the request. If the first member is not in an active state, the JMX request is forwarded to a currently active member of the plurality of members for processing the request. The invention thus permits users to communicate with the group via JMX without knowing which member of the group is active at any particular time.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. [0041] Furthermore, the invention can take the form of a computer program product accessible from a computer-usable or computer-readable medium providing program code instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk - read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for processing JMX requests to a managed group that includes a plurality of group members, the computer implemented method comprising:
transmitting a JMX request to a first member of a group comprising a plurality of group members;
determining if the first member is in an active state; and
if the first member is not in an active state, forwarding the JMX request to a currently active member of the plurality of group members for processing the JMX request.

2. The computer implemented method according to claim 1, wherein transmitting a JMX request to a first member of a group comprising a plurality of group members, comprises:
transmitting the JMX request via a connection to an identified member of the group.

3. The computer implemented method according to claim 1, and further including:
sending a response to the request to a requester from the first member.

4. The computer implemented method according to claim 1, and further including:
wherein if the first member is currently in an active state, the first member processes the request and returns a response to the request to a requestor.

5. The computer implemented method according to claim 4, and further including:
electing a further member of the plurality of group members to be in an active state if a member that is in a currently active state goes down.

6. The computer implemented method according to claim 5, wherein electing a further member of the plurality of group members to be in an active state if a member that is in a currently active state goes down, comprises:
changing an MBean for the further member of the plurality of group members to reflect the election.

7. The computer implemented method according to claim 1, wherein the data processing system comprises a data processing system that incorporates WebSphere® software.

8. Apparatus for processing JMX requests to a managed group that includes a plurality of group members, comprising:
a manager for managing the managed group, wherein the manager determines if a first member of the group that receives a JMX request is in an active state, and if the first member is not in an active state, forwards the JMX request to a currently active member of the plurality of group members for processing the JMX request.

9. The apparatus according to claim 8, wherein if the first member is currently in an active state, the JMX request is processed by the first member.

10. The apparatus according to claim 8, wherein the manager includes a mechanism for electing a further member of the plurality of group members to be in an active state if a member that is in a currently active state goes down, and wherein the apparatus further comprises:
an MBean for each of the plurality of group members, the manager changing the MBean of the further member of the plurality of group members to reflect the election.

11. The apparatus according to claim 8, wherein the data processing system comprises a data processing system that incorporates WebSphere software.

12. A computer program product for processing JMX requests to a managed group that includes a plurality of group members, the computer program product comprising:
a computer readable medium having computer readable program code embodied therein;
computer readable program code configured to transmit a JMX request to a first member of a group comprising a plurality of group members;
computer readable program code configured to determine if the first member is in an active state; and
if the first member is not in an active state, computer readable program code configured to forward the JMX request to a currently active member of the plurality of group members for processing the JMX request.

13. The computer program product according to claim 12, wherein the computer readable program code configured to transmit a JMX request to a first member of a group comprising a plurality of group members comprises:
computer readable program code configured to transmit the JMX request via a connection to an identified member of the group.

14. The computer program product according to claim 12, and further including:
computer readable program code configured to send a response to the request to a requester from the first member.

15. The computer program product according to claim 12, and further including:
wherein if the first member is currently in an active state, computer readable program code configured for the first member to process the request and return a response to the request to a requester.

16. The computer program product according to claim 15, and further including:
computer readable program code configured to elect a further member of the plurality of group members to be in an active state if a member that is in a currently active state goes down.

17. The computer program product according to claim 16, wherein the computer readable program code configured to elect a further member of the plurality of group members to be in an active state if a member that is in a currently active state goes down comprises:
computer readable program code configured to change an MBean for the further member of the plurality of group members to reflect the election.
